(19) United States
(12) Patent Application Publication
(10) Pub. No.: US 2022/0004603 A1
(43) Pub. Date: Jan. 6, 2022

(54) METHOD FOR CONTROLLING DEVICE THROUGH APPLICATION, AND APPARATUS AND SYSTEM FOR PERFORMING THE SAME

(71) Applicant: BIXOLON CO., LTD., Seongnam-si (KR)

(72) Inventor: Choeun JEONG, Seongnam-si (KR)

(73) Assignee: BIXOLON CO., LTD., Seongnam-si (KR)

(21) Appl. No.: 17/363,633

(22) Filed: Jun. 30, 2021

(30) Foreign Application Priority Data
Jul. 1, 2020 (KR) 10-2020-0080794

(51) Int. Cl. G06F 21/10; G06F 21/12; G06F 21/31; G06F 21/60

(52) U.S. Cl. CPC G06F 21/105; G06F 21/121; G06F 2221/0751; G06F 21/602; G06F 21/31

(57) ABSTRACT

Disclosed herein are a method for controlling a device through an application installed on a host device, and an apparatus and system for performing the same. The method for controlling a device through an application includes: receiving a request requiring a device to perform a specific operation through an application installed on a host device; checking, by the host device, whether the performance of the specific operation using the device is permitted by using information stored in the device; and, when it is determined that the performance of the specific operation using the device is permitted, requesting, by the host apparatus, the device to perform the specific operation.

### CROSS-REFERENCE TO RELATED APPLICATION

This application claims the benefit of Korean Patent Application No. 10-2020-0080794 filed on Jul. 1, 2020, which is hereby incorporated by reference herein in its entirety.

### BACKGROUND

### 1. Technical Field

The embodiments disclosed herein relate to a method for controlling a device through an application installed on a host device, and an apparatus and system for performing the same.

### 2. Description of the Related Art

There are cases where it is required that a user have the right to perform a specific function when he or she performs the specific function through an application. In these cases, it may be possible to prove that the user has the right by issuing a license key.

When the user requests the performance of the function requiring the license key through the application, it may be determined whether the license key is present, it may be determined whether the license key is valid when the license key is present, and the performance of the corresponding function may be permitted only when the license key is valid.

For example, when a PDF file is printed through an application installed on a mobile terminal, the application must use a PDF library, so that the right to use the PDF library is required. In this case, a license key may be issued in advance to prove the presence of the right.

Furthermore, the issued license key may be stored somewhere in advance. Thereafter, when a request for the printing of a PDF file is received through the application, the license key stored in advance may be checked for validity, and then the PDF file may be printed only when the validity of the license key is recognized.

Therefore, there is an increasing demand for the development of a technology for efficiently performing the processes of issuing, storing, and performing a validity check for a license key that can be used in the above-described manner.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

The embodiments disclosed herein are directed to a method and apparatus for checking whether a license required for a device to perform a specific operation is present when controlling the device through an application installed on a host device.

As a technical solution for accomplishing the above objects, according to an embodiment, there is provided a method for controlling a device through an application, the method including: receiving a request, requiring a device to perform a specific operation, through an application installed on a host device; checking, by the host device, whether the performance of the specific operation using the device is permitted by using information stored in the device; and, when it is determined that the performance of the specific operation using the device is permitted, requesting, by the host apparatus, the device to perform the specific operation.

According to another embodiment, there is provided a computer program that is executed by a host device and stored in a medium in order to perform a method for controlling a device through an application, the method including: receiving a request, requiring a device to perform a specific operation, through an application installed on a host device; checking, by the host device, whether the performance of the specific operation using the device is permitted by using information stored in the device; and, when it is determined that the performance of the specific operation using the device is permitted, requesting, by the host apparatus, the device to perform the specific operation.

According to still another embodiment, there is provided a non-transitory computer-readable storage medium having stored thereon a program that, when executed by a processor, causes the processor to perform a method for controlling a device through an application, the method including: receiving a request, requiring a device to perform a specific operation, through an application installed on a host device; checking, by the host device, whether the performance of the specific operation using the device is permitted by using information stored in the device; and, when it is determined that the performance of the specific operation using the device is permitted, requesting, by the host apparatus, the device to perform the specific operation.

According to still another embodiment, there is provided an apparatus for controlling a device through an application, the apparatus including: a communication interface configured to communicate with a device and an authentication server; an input/output interface configured to receive an input from a user and display the execution screen of the application; storage configured such that the application is stored thereon; and a controller configured to control the device to perform a specific operation through the application; wherein, when receiving a request, requiring the device to perform the specific operation, through the application, the controller checks whether the performance of the specific operation using the device is permitted by using information stored in the device, and requests the device to perform the specific operation when it is determined that the performance of the specific operation using the device is permitted.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing a printing system according to an embodiment;

FIG. 2 is a diagram showing the configuration of a host device included in a printing system according to an embodiment;

FIG. 3 is a diagram illustrating the process of newly issuing a license key for printing through an application in a printing system according to an embodiment;

FIG. 4 is a diagram illustrating the process of checking a license key for validity when a print request is received through an application in a printing system according to an embodiment; and

FIGS. 5 to 9 are flowcharts illustrating methods of performing printing through an application according to embodiments.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

The embodiments to be described below are directed to methods for allowing a device to perform a specific operation through an application. More specifically, the embodiments to be described below are directed to methods for performing control so that, when a user requests a device to perform a specific operation through an application installed on a host device and a license is required for the device to perform the corresponding operation, the operation is performed based on the result of checking whether a license key stored in the device is valid.

In this case, the specific operation performed by the device may be, for example, an operation in which the device downloads and updates firmware, an operation in which the device accesses a cloud server, an operation in which the device prints a file (e.g., a PDF file) in a specific format when the device is a printing device, or the like. However, it is not limited thereto, but may include various types of operations. However, for ease of description, embodiments in which the “device” is a “printing device” and the “specific operation” is “printing a PDF file” will be described below.

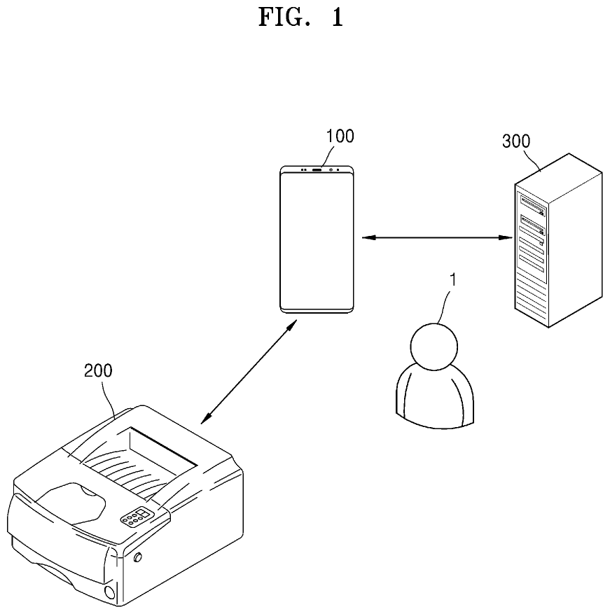

FIG. 1 is a diagram showing a printing system according to an embodiment. Referring to FIG. 1, the printing system according to the present embodiment may include a host device 100, a printing device 200, and an authentication server 300.

A user 1 may request printing using the printing device 200 through an application installed on the host device 100. In the following description, it is assumed that the user 1 requests the printing of a PDF file through the application. However, it is obvious that any type of file requiring access to a specific library for printing may be equally applied to the following embodiments even when it is not a PDF file.

When the host device 100 receives a request for the printing of a PDF file, the host device 100 performs the process of requesting a license key to the printing device 200 and performs a validation process in order to check whether the user 1 has the right to access the PDF library. A specific process in which the host device 100 determines the validity of the license key using information stored in the printing device 200 will be described below with reference to other drawings.

The authentication server 300 may issue a license key or check for the validity of a license key in response to a request from the host device 100. To this end, the authentication server 300 may store information related to the license key in advance. A detailed process in which the authentication server 300 issues a license key and checks for the validity of a license key will be described below with reference to other drawings.

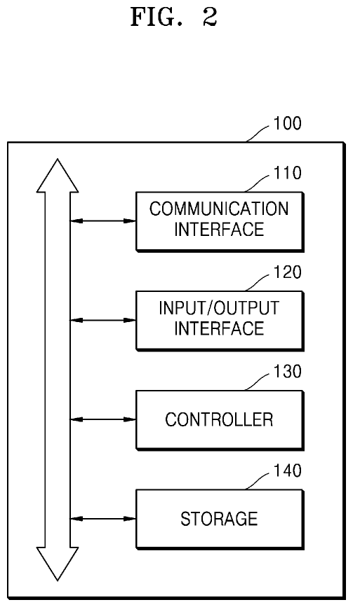

FIG. 2 is a diagram showing the configuration of a host device included in a printing system according to an embodiment. Referring to FIG. 2, the host device 100 according to the present embodiment may include a communication interface 110, an input/output interface 120, a controller 130, and storage 140.

The communication interface 110 is a component configured to perform wired/wireless communication with the printing apparatus 200 and the authentication server 300, and may be implemented as a communication chipset configured to support various communication protocols.

The input/output interface 120 is a component configured to receive an input such as an application execution request or a print request from the user 1 and display the UI screen of an application or printing results, and may be implemented, for example, as a touch screen.

The controller 130 is a component including at least one processor such as a central processing unit (CPU), and controls the overall operation of the host device 100. In particular, the controller 130 may perform control to execute an application stored in the storage 140, to check whether the user 1 has the right when printing a PDF file through the application, and to print the PDF file.

The storage 140 includes volatile memory and non-volatile memory. Various types of programs and data may be stored in the storage 140. In particular, an application configured to print PDF files, a PDF library, etc. may be stored in the storage 140.

A specific process in which the printing system prints a PDF file through an application will be described in detail below.

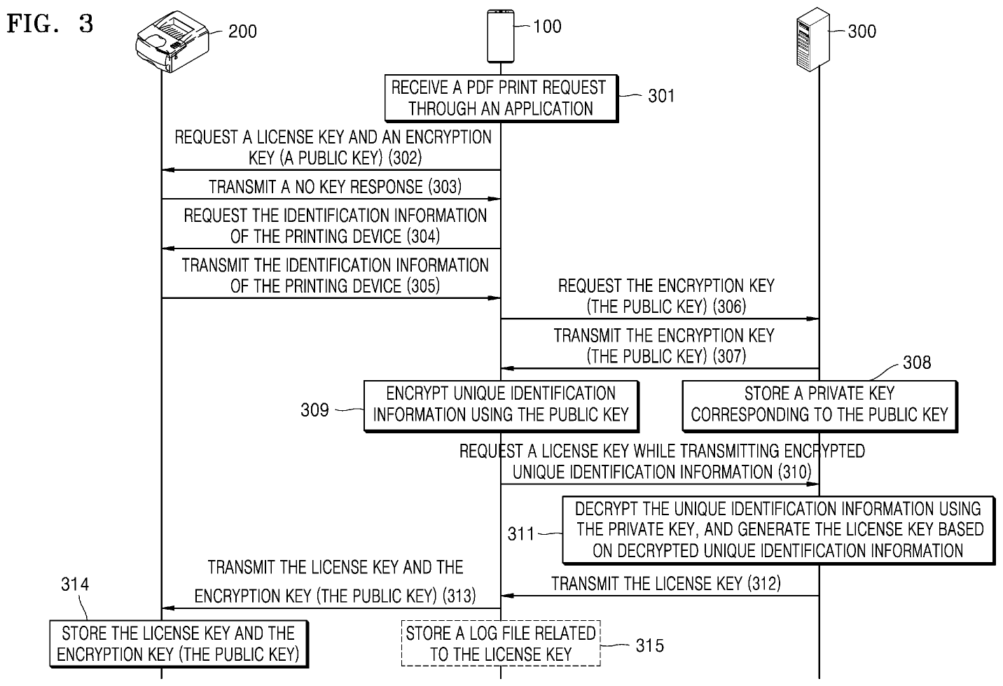

FIG. 3 is a diagram illustrating the process of newly issuing a license key for printing through an application in a printing system according to an embodiment.

Referring to FIG. 3, when the host device 100 receives a PDF print request through the application from the user 1 at step 301, the host device 100 requests a license key and a public key corresponding to the application to the printing device 200 at step 302.

When the printing device 200 transmits a response indicating that it does not have the license key and the public key to the host device 100 at step 303, the host device 100 starts the process of newly issuing a license key.

In order to be newly issued with a license key, unique identification information is required. In this case, the ‘unique identification information’ is information required to check whether the user 1 has the right to be issued with a license key and to ensure the uniqueness of the license key. The unique identification information may include the identification information of the host device 100 (e.g., a model name, a serial number, a device ID, an IMEI number, a MAC address, and/or the like), the identification information of the application, and the identification information of the printing apparatus 200 (e.g., a model name, a MAC address, a serial number, and/or the like), and may further include the ID of the user 1 in the application. Alternatively, the unique identification information may be generated by combining two or more of the above-described types of information and the IP addresses of the host device 100 and the printing device 200.

To collect unique identification information, the host device 100 may request the identification information of the printing device 200 to the printing device 200 at step 304, and may receive it at step 305.

When the host device 100 requests an encryption key (a public key) to the authentication server 300 at step 306, the authentication server 300 transmits the public key to the host device 100 at step 307, and stores a private key corresponding to the transmitted public key in the memory of the authentication server 300 at step 308.

The host device 100 encrypts the unique identification information using the public key received from the authentication server 300 at step 309, and requests the issuance of a license key while transmitting the encrypted unique identification information to the authentication server 300 at step 310. Since the unique identification information is information requiring security, it is always encrypted and then transmitted and received. To this end, the host device 100 shares the encryption key with the authentication server 300 through steps 306 to 308.

At step 311, the authentication server 300 decrypts the received unique identification information using the private key stored in advance, and generates a license key based on the decrypted unique identification information. The authentication server 300 may manage the license key by generating the license key so that the license key includes at least a part of the unique identification information.

When the generation of the license key is completed, the authentication server 300 transmits the license key to the host device 100 at step 312.

The host device 100 requests the storage of the received license key and the public key while transmitting the received license key and the public key to the printing device 200 at step 313, and the printing device 200 stores the received license key and the public key at step 314. The printing apparatus 200 may securely store the license key and the public key even upon the occurrence of a situation, such as the update of firmware, by storing the license key and the public key in non-volatile memory.

At step 315, the host device 100 may store a log file related to the license key. The reason for this is to check whether the printing device 200 has a license for the printing of a PDF file without requesting a validity check while transmitting the license key to the authentication server 300 whenever a request for the printing of a PDF file is received through the application later. The step of storing a log file related to the license key is optional as described above. If the host device 100 checks the license of the printing device 200 while communicating with the authentication server 300 whenever there is a request for the printing of a PDF file, the host device 100 may not store a log file.

The date and time when a validity check for the corresponding license key was performed, the model name and serial number of the host device 100, the model name and serial number of the printing device 200, and whether the license expires (i.e., the period of validity of the license key) may be encrypted and stored in the log file.

Meanwhile, when the printing device 200 does not have a valid license key, the host device 100 may check whether another printing device (not shown) has a valid license key and request printing to the other printing device when it is determined that the other printing device has a valid license key, instead of allowing the former printing device 200 to be newly issued with a license key.

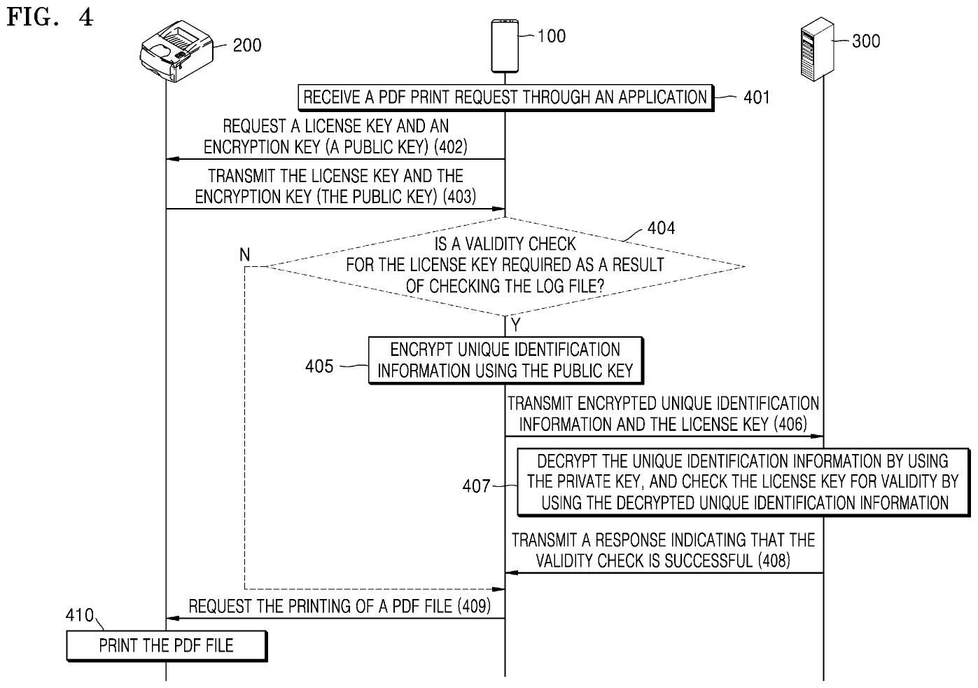

For example, the host device 100 requests a license key and an encryption key to another printing device after step 303 of FIG. 3, and may perform a process that is the same as the process of steps 304 to 315 of FIG. 3 or the process of steps 404 to 410 of FIG. 4 to be described later on another printing device depending on the response.

When the host device 100 requests a license key required to perform a specific operation (e.g., printing) to any one device (e.g., a printing device) as described above but the device does not have the license key, it may immediately request a license key to another device, thereby enabling the specific operation to be rapidly processed.

Meanwhile, FIG. 3 illustrates an example in which the host device 100 is issued a license key from the authentication server 300 using the identification information of the printing device 200 when there is no license key in the printing device 200 (steps 304 through 312), but in contrast, the user can directly input the license key value obtained through various paths (e.g. the key value may be received after purchasing the license key through the web page) through the host device 100, and the authentication server 300 may check whether the entered key value is a valid license key. If the authentication server 300 confirms that it is a valid license key value, the host device 100 may transmit the license key to the printing device 200 and request the storage of the license key.

FIG. 4 is a diagram illustrating the process of checking a license key for validity when a print request is received through an application in a printing system according to an embodiment.

Referring to FIG. 4, when the host device 100 receives a PDF print request through an application from the user 1 at step 401, the host device 100 requests a license key and a public key corresponding to the application to the printing device 200 at step 402.

In this case, the reason why the host device 100 requests the public key to the printing device 200 is to encrypt unique identification information when a validity check for the license key is required. Referring to the process described in FIG. 3 above, when a license key is newly issued, the host device 100 receives the public key from the authentication server 300 but stores it in the printing device 200 without storing it therein. The reason for this is that when the public key is stored in the host device 100, there is a higher risk of loss of the public key because data is frequently stored and deleted in the host device 100. In contrast, in the case of the printing apparatus 200, the frequency at which data is stored or deleted is lower except for a situation such as the update of firmware, so that when the public key is stored once, the risk of loss of the public key is lower than that in the host device 100. As described above, the host device 100 stores both the license key and the public key in the printing device 200 for the purpose of the safe storage of the public key, and may check whether printing is permitted by using only the information (the license key and the public key) stored in the printing apparatus 200 when a PDF print request is made.

When the printing device 200 transmits the license key and the public key to the host device 100 at step 403, the host device 100 checks a log file related to the received license key and determines whether a validity check for the license key is required by checking the log file at step 404.

For example, when the log file related to the received license key is not present or is present but damaged, the host device 100 determines that a validity check for the license key is required and then proceeds to step 405. Alternatively, for example, referring to the date and time when a validity check for the license key stored in the log file was performed, when a predetermined or longer period of time has elapsed since the last time a validity check for the license key was performed, the host device 100 may determine that a validity check for the license key is required.

The host device 100 encrypts the unique identification information using the public key received from the printing device 200 at step 405, and the host device 100 transmits the encrypted unique identification information and the license key to the authentication server 300 and requests a validity check for the license key at step 406.

At step 407, the authentication server 300 decrypts the received unique identification information using a previously stored private key, and checks the license key for validity based on the decrypted unique identification information. In greater detail, the authentication server 300 determines whether a license key stored in advance to match the decrypted unique identification information matches the license key received from the host device 100, and may determine that the validity of the license key is recognized when the two license keys match each other.

When the authentication server 300 transmits a response indicating that the validity check for the license key is successful to the host device 100 at step 408, the host device 100 transmits a request for the printing of a PDF file to the printing device 200 at step 409, and the printing apparatus 200 prints the PDF file at step 410.

Meanwhile, when, as a result of checking the log file, it is determined at step 404 that a validity check for the license key is not required, the host device 100 immediately proceeds to step 409 and requests the printing device 200 to print the PDF file, and the printing apparatus 200 prints the PDF file at step 410. For example, referring to the date and time when the validity check for the license key stored in the log file was performed, when the predetermined period of time has not elapsed since the last time the validity check for the license key was performed, the host device 100 may determine that validity check for the license key is not required. Alternatively, when the period of validity of the license key stored in the log file is not expired, the host device 100 may determine that a validity check for the license key is not required.

Meanwhile, when the printing device 200 does not have a valid license key, the host device 100 may check whether another printing device (not shown) has a valid license key. When it is determined that the other printing device has a valid license key, the host device 100 may request printing to the other printing device.

For example, when the authentication server 300 checks the license key for validity and determines that the license key is not valid at step 407 of FIG. 4, the host device 100 may request a license key and an encryption key to another printing device, and may perform a process that is the same as the process of steps 304 to 315 of FIG. 3 or the process of steps 404 to 410 of FIG. 4 on the other printing device depending on a response to the request.

When the host device 100 requests a license key required to perform a specific operation (e.g., printing) to any one device (e.g., a printing device) as described above but the device does not have a valid license key, it may immediately request a license key to another device, thereby enabling the specific operation to be rapidly processed.

In other words, when the host device 100 checks whether the performance of a specific operation using any one device (e.g. a printing device) is permitted by using information stored in the device but it is determined that the performance of the specific operation using the device is not permitted, the host device 100 may immediately check whether the performance of a specific operation using another device is permitted by using information stored in the other device, and may request the other device to perform the specific operation when it is determined that the performance of the specific operation using the other device is permitted.

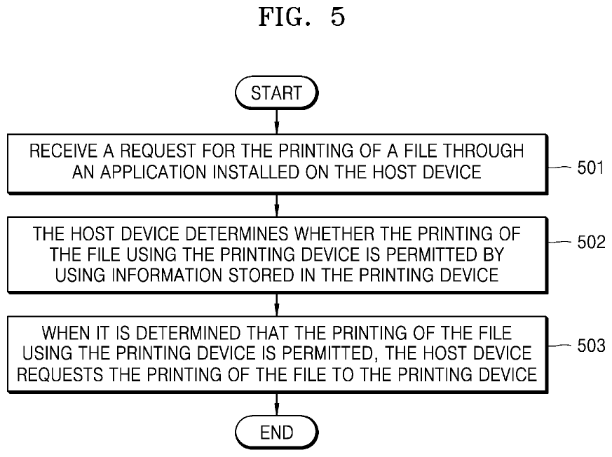

A method of performing printing through an application in the above-described printing system will be described below. FIGS. 5 to 9 are flowcharts illustrating methods of performing printing through an application according to embodiments. The methods of performing printing through an application according to the embodiments shown in FIGS. 5 to 9 include steps that are performed by the printing system shown in FIGS. 1 to 4 in a time-series manner. Accordingly, the descriptions that are omitted below but are given above in connection with the printing system shown in FIGS. 1 to 4 may also be applied to the methods of performing printing through an application according to the embodiments shown in FIGS. 5 to 9.

Referring to FIG. 5, when a request for the printing of a file is received through an application installed on the host device at step 501, the host device determines whether the printing of a file using the printing device is permitted by using information stored in the printing device at step 502.

When it is determined at step 503 that the printing of the file using the printing device is permitted, the host device requests the printing device to print the file.

As described above, the host device stores information, required to check whether the printing of a file is permitted, in the printing device rather than directly storing it and accesses it whenever a print request is made. The reason for this is that there is an advantage in that information can be securely stored because the frequency at which the storage or deletion of data is performed in the printing device is lower than the frequency at which the storage or deletion of data is performed in the host device due to the characteristics of the devices.

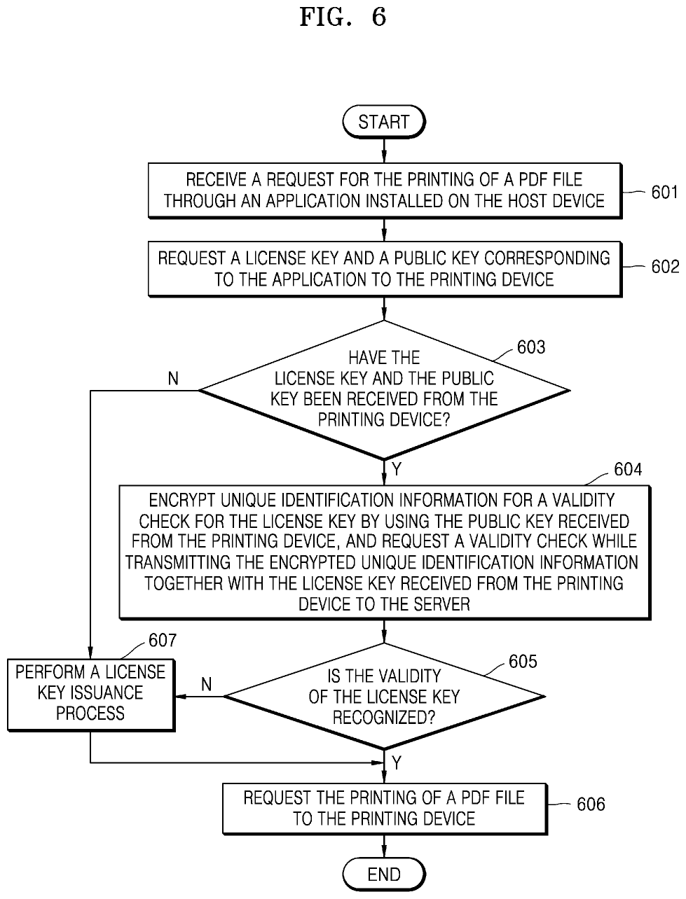

FIG. 6 shows an embodiment in which a license key is newly issued or a license key is checked for validity depending on whether a license key and a public key are received from the printing device.

Referring to FIG. 6, when a request for the printing of a PDF file is received through an application installed on the host device at step 601, the host device requests a license key and a public key corresponding to the application to the printing device at step 602.

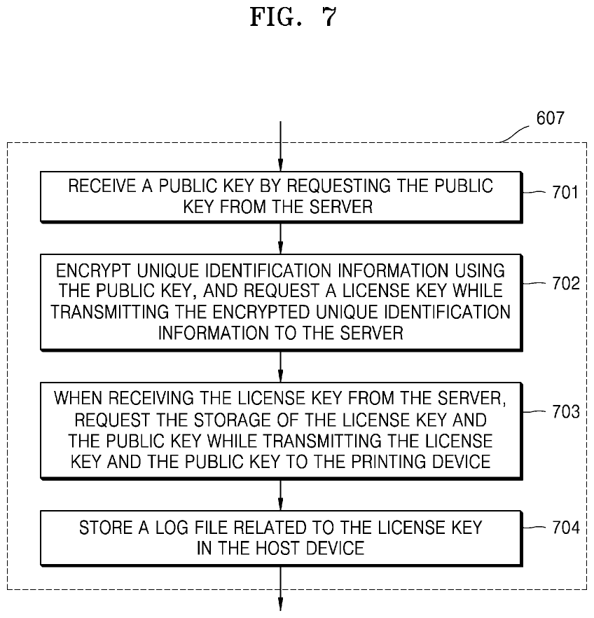

At step 603, the host device determines whether a license key and a public key have been received from the printing device. When the host device receives a response indicating that there is no license key and public key from the printing device, the host device proceeds to step 607 and performs a new license key issuance process. Detailed steps included in step 607 are illustrated in FIG. 7.

Referring to FIG. 7, at step 701, the host device receives a public key by requesting the public key from the server. Thereafter, at step 702, the host device encrypts unique identification information using the public key received from the server, transmits it to the server, and requests a license key. The server may decrypt the received unique identification information using a private key stored in advance, may generate a license key using the decrypted unique identification information, and may transmit the license key to the host device.

When the host device receives the license key from the server, it requests the storage of the license key and the public key by transmitting the license key and the public key to the printing device at step 703, and stores a log file related to the license key in the host device at step 704.

Referring back to FIG. 6, when it is determined at step 603 that the host device has received the license key and the public key from the printing device, the host device proceeds to step 604, at which the host device encrypts unique identification information for a validity check for the license key by using the public key received from the printing device, and requests a validity check while transmitting the encrypted unique identification information together with the license key received from the printing device.

At step 605, the host device determines whether the validity of the license key is recognized. When the validity is not recognized, the host device proceeds to step 607 and performs a new license key issuance process in contrast, when the validity is recognized, the host device proceeds to step 606 and requests the printing device to print a PDF file.

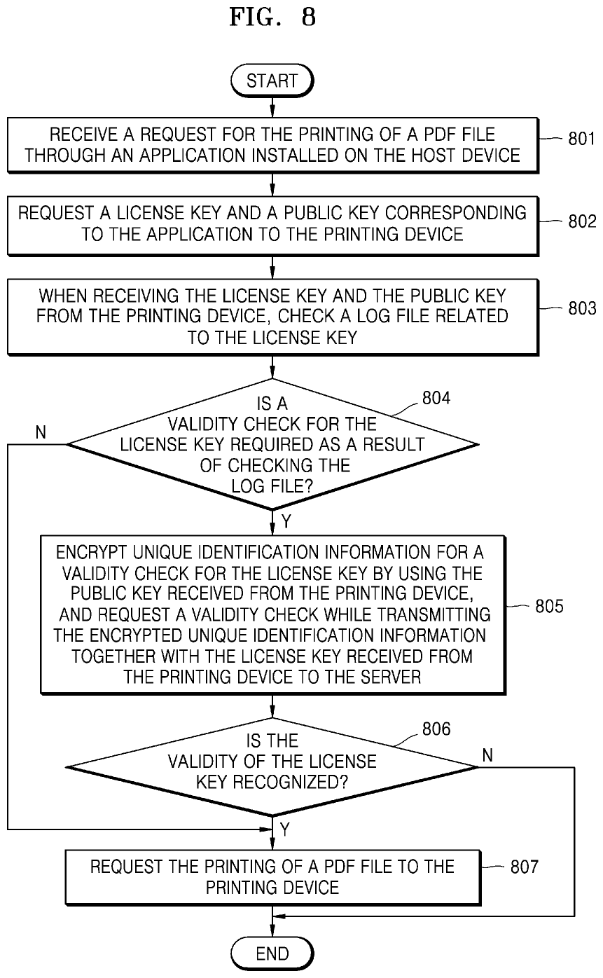

FIG. 8 shows an embodiment in which when a predetermined condition is satisfied by checking a log file stored in the host device, a validity check for a license key is omitted and then printing is performed.

Referring to FIG. 8, when a request for the printing of a PDF file is received through an application installed on the host device at step 801, the host device requests a license key and a public key corresponding to the application to the printing device at step 802.

At step 803, when the host device receives the license key and the public key from the printing device, the host device checks a log file related to the license key.

At step 804, the host device determines whether a validity check for the license key is required by checking the log file. A method of determining whether a validity check for a license key is required by checking a log file is the same as that described above with reference to FIG. 4.

When it is determined that a validity check for the license key is required, the host device proceeds to step 805, at which the host device encrypts unique identification information for the validity check for the license key by using the public key received from the printing device, and then requests the validity check while transmitting the encrypted unique identification information to the server along with the license key.

The host device determines whether the validity of the license key is recognized at step 806. When the validity is recognized, the host device may proceed to step 807 and may request the printing device to print a PDF file. In contrast, when the validity of the license key is not recognized, the host device terminates the process. In this case, even when the validity of the license key is not recognized, the host device may perform the process of newly issuing a license key such as that shown at step 607 of FIG. 6 rather than immediately terminating the process.

Meanwhile, when it is determined at step 804 that a validity check for the license key is not required, the host device proceeds to step 907 and requests the printing device to print the PDF file.

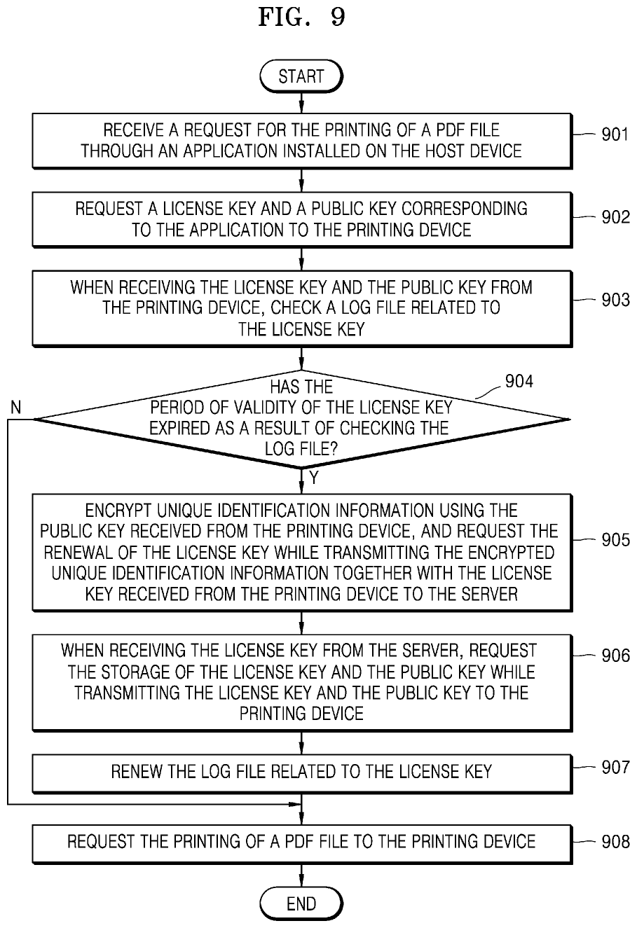

FIG. 9 shows an embodiment in which whether a license has expired is checked by checking the log file stored in the host device and the license is renewed when the license has expired.

Referring to FIG. 9, when a request for the printing of a PDF file is received through an application installed on the host device at step 901, the host device requests a license key and a public key corresponding to the application to the printing device at step 902.

At step 903, when the host device receives the license key and the public key from the printing device, the host device checks a log file related to the license key.

When the host device determines that the license key has expired by checking the log file at step 904, the host device proceeds to step 905, at which the host device encrypts the unique identification information using the public key received from the printing device and requests the renewal of the license key while transmitting the encrypted unique identification information together with the license key received from the printing device to the server. The server may decrypt the unique identification information using a private key stored in advance, and may determine whether to permit the renewal of the license key by using the decrypted unique identification information. For example, when, as a result of checking a user ID included in the unique identification information, it is determined that a license extension fee has been paid, it may be determined that the renewal of the license key is permitted, and a renewed license key may be transmitted to the host device.

At step 906, when the host device receives the license key from the server, the host device requests the storage of the license key and the public key while transmitting them to the printing device. At step 907, a log file related to the license key is stored in the host device. Information included in the log file is the same as described above.

Finally, at step 908, the host device requests the printing device to print the PDF file.

Meanwhile, when it is determined at step 904 that the period of validity of the license key has not yet expired, the host device immediately proceeds to step 908 and requests the printing device to print the PDF file.

As described above, a log file related to a license key is stored in the host device when the license key is issued or renewed, and the validity of the license key is determined using the stored log file when a print request is made later, so that there is an advantage in that whether the printing of a file is permitted can be checked without having to perform authentication through the server every time printing is performed.

The term ‘unit’ used in the above-described embodiments means software or a hardware component such as a field-programmable gate array (FPGA) or application-specific integrated circuit (ASIC), and a ‘unit’ performs a specific role. However, a ‘unit’ is not limited to software or hardware. A ‘unit’ may be configured to be present in an addressable storage medium, and also may be configured to run one or more processors. Accordingly, as an example, a ‘unit’ includes components, such as software components, object-oriented software components, class components and task components, processes, functions, attributes, procedures, subroutines, segments in program code, drivers, firmware, microcode, circuits, data, a database, data structures, tables, arrays, and variables.

Each of the functions provided in components and ‘unit (s)’ may be coupled to a smaller number of components and ‘unit(s)’ or divided into a larger number of components and ‘unit (s).’

In addition, components and ‘unit(s)’ may be implemented to run one or more CPUs in a device or secure multimedia card.

Each of the methods of performing printing through an application according to the embodiments described with reference to FIGS. 5 to 9 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSE, or the like, an optical storage medium such as a CD, a DVD, a Blu-ray disk or the like, or memory included in a server that can be accessed over a network.

Furthermore, each of the methods of performing printing through an application according to the embodiments described with reference to FIGS. 5 to 9 may be implemented as a computer program (or a computer program product) including computer-executable instructions. The computer program includes programmable machine instructions that are processed by a processor, and may be implemented as a high-level programing language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, each of the methods of performing printing through an application according to the embodiments described with reference to FIGS. 5 to 9 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set, of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to any one of the above-described technical solutions, information (a license key and a public key) used to determine whether a specific operation of a device is permitted is stored in the device instead of the host device where data is stored and deleted frequently, and the host device is accessed only when necessary, so that an advantage arises in that the information can be securely managed.

Furthermore, a log file related to a license key is stored when the license key is issued or renewed, and the validity of the license key is determined using the stored log file when a print request is made later, so that an advantage arises in that whether the printing of a file is permitted can be checked without having to perform authentication through the server every time printing is performed.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the detailed description. All modifications and variations which can be derived from the meanings, scopes and equivalents of the claims should be construed as falling within the scope of the present invention.

What is claimed is:

1. A method for controlling a device through an application, the method comprising:
receiving a request, requiring a device to perform a specific operation, through an application installed on a host device;
checking, by the host device, whether performance of the specific operation using the device is permitted by using information stored in the device; and
when it is determined that the performance of the specific operation using the device is permitted, requesting, by the host apparatus, the device to perform the specific operation.

2. The method of claim 1, wherein checking whether the performance of the specific operation is permitted comprises:
requesting, by the host device, a license key and a public key corresponding to the application to the device;
when the host device receives the license key and the public key from the device, encrypting, by the host device, unique identification information using the public key, and requesting, by the host device, determination of validity of the license key to an authentication server while transmitting the encrypted unique identification information and the license key to the authentication server;
decrypting, by the authentication server, the encrypted unique identification information using the private key stored in advance, and determining, by the authentication server, the validity of the license key using the decrypted unique identification information; and
determining, by the host device, that the performance of the specific operation is permitted when the host device receives a response indicating that the license key is valid from the authentication server.

3. The method of claim 2, wherein determining the validity of the license key comprises:
determining, by the authentication server, whether a license key stored in advance to match the decrypted unique identification information matches the license key received from the host device; and
determining, by the authentication server, that the validity of the license key is recognized when the two license keys match each other

4. The method of claim 1, wherein checking whether the performance of the specific operation is permitted comprises:
requesting, by the host device, a license key and a public key corresponding to the application to the device;
when the host device receives the license key and the public key from the device, checking, by the host device, a log file related to the license key; and
determining, by the host device, that the performance of the specific operation is permitted when, as a result of checking the log file, it is determined that the determination of the validation of the license key is not required.

5. The method of claim 1, wherein checking whether the performance of the specific operation is permitted comprises:
requesting, by the host device, a license key and a public key corresponding to the application to the device;
when the host device receives the license key and the public key from the device, checking, by the host device, a log file related to the license key;
when, as a result of checking the log file, the log file related to the license key is not present or is damaged, encrypting, by the host device, unique identification information using the public key, and requesting, by the host device, determination of validity of the license key to the authentication server while transmitting the encrypted unique identification information and the license key to the authentication server; and
determining, by the host device, that the performance of the specific operation is permitted when the host device receives a response indicating that the license key is valid from the authentication server.

6. The method of claim 1, wherein checking whether the performance of the specific operation is permitted comprises:
requesting, by the host device, a license key and a public key corresponding to the application to the device;
when the host device receives the license key and the public key from the device, checking, by the host device, a log file related to the license key;
when, as a result of checking the log file, a period of validity of the license key has expired, encrypting, by the host device, unique identification information using the public key, and requesting, by the host device, renewal of the license key to the authentication server while transmitting the encrypted unique identification information and the license key to the authentication server;
when the host device receives a renewed license key from the authentication server, determining, by the host device, that the performance of the specific operation is permitted, and requesting, by the host device, storage of the renewed license key and the public key to the device while transmitting the updated license key and the public key to the device; and
renewing the log file.

7. The method of claim 2, wherein the unique identification information is generated by combining two or more of identification information of the host device, identification information of the application, and identification information of the device.

8. The method of claim 2, wherein the license key is indicative of a right to use a library required to perform the specific operation.

9. A non-transitory computer-readable storage medium having stored thereon a program that, when executed by a processor, causes the processor to perform the method set forth in claim 1.

10. An apparatus for controlling a device through an application, the apparatus comprising:
a communication interface configured to communicate with a device and an authentication server;
an input/output interface configured to receive an input from a user and display an execution screen of the application;
storage configured such that the application is stored thereon; and
a controller configured to control the device to perform a specific operation through the application;
wherein, when receiving a request, requiring the device to perform the specific operation, through the application, the controller checks whether performance of the specific operation using the device is permitted by using information stored in the device, and requests the device to perform the specific operation when it is determined that the performance of the specific operation using the device is permitted.

11. The apparatus of claim 10, wherein, when checking whether the performance of the specific operation is permitted, the controller:
requests a license key and a public key corresponding to the application to the device;
when receiving the license key and the public key from the device, encrypts unique identification information using the public key, and requests determination of validity of the license key to an authentication server while transmitting the encrypted unique identification information and the license key to the authentication server; and
determines that the performance of the specific operation is permitted when receiving a response indicating that the license key is valid from the authentication server.

12. The apparatus of claim 10, wherein, when checking whether the performance of the specific operation is permitted, the controller:
requests a license key and a public key corresponding to the application to the device;
when receiving the license key and the public key from the device, checks a log file related to the license key; and
determines that the performance of the specific operation is permitted when, as a result of checking the log file, it is determined that the determination of the validation of the license key is not required.

13. The apparatus of claim 10, wherein, when checking whether the performance of the specific operation is permitted, the controller:
requests a license key and a public key corresponding to the application to the device;
when receiving the license key and the public key from the device, checks a log file related to the license key;
when, as a result of checking the log file, the log file related to the license key is not present or is damaged, encrypts unique identification information using the public key, and requests determination of validity of the license key to the authentication server while transmitting the encrypted unique identification information and the license key to the authentication server; and
determines that the performance of the specific operation is permitted when the host device receives a response indicating that the license key is valid from the authentication server.

14. The apparatus of claim 10, wherein, when checking whether the performance of the specific operation is permitted, the controller:
requests a license key and a public key corresponding to the application to the device;
when receiving the license key and the public key from the device, checks a log file related to the license key;
when, as a result of checking the log file, a period of validity of the license key has expired, encrypts unique identification information using the public key, and requests renewal of the license key to the authentication server while transmitting the encrypted unique identification information and the license key to the authentication server;
when receiving a renewed license key from the authentication server, determines that the performance of the specific operation is permitted, and requests storage of the renewed license key and the public key to the device while transmitting the updated license key and the public key to the device; and
renews the log file.

15. The apparatus of claim 11, wherein the unique identification information is generated by combining two or more of identification information of the host device, identification information of the application, and identification information of the device.

16. The apparatus of claim 11, wherein the license key is indicative of a right to use a library required to perform the specific operation.
